(19) United States
(12) Patent Application Publication
(10) Pub. No.: US 2011/0068129 A1
(43) Pub. Date: Mar. 24, 2011

(54) SHEET ROLL DISPENSER

(76) Inventor: Scott D. Maurer, Rocky River, OH (US)

(21) Appl. No.: 12/915,457

(22) Filed: Oct. 29, 2010

Related U.S. Application Data
(63) Continuation-in-part of application No. 12/103,508, filed on Apr. 15, 2008.

(51) Int. Cl. A47K 10/38; B65H 23/00; A47K 10/36; B67D 7/06; B65H 35/10

(52) U.S. Cl. 222/192; 242/566; 225/93

(57) ABSTRACT

A sheet roll dispenser includes a roll carrier and a restraining device. The roll carrier is configured to support an associated roll of fibrous sanitary tissue product, e.g. a roll of paper towels or a roll of toilet paper. The roll carrier includes a mouth adjacent a sheet roll outlet of the case. The restraining device is located on the mouth of the roll carrier and includes a plurality of flexible fibers having distal ends defining a fiber tip curve. A method for dispensing sheet roll material and a fluid dispenser for use with the sheet roll dispenser are also disclosed.

This application is a continuation-in-part of application Ser. No. 12/103,508, filed Apr. 15, 2008, which is incorporated by reference in its entirety herein.

### BACKGROUND

The present disclosure generally relates to devices for holding and dispensing a roll of sheet roll material, e.g., toilet tissue and paper towels. In most household water closets and public restrooms, a roll of toilet tissue hangs from a spring-loaded cylindrical rod attached between two supports. It is also known to mount a roll of paper towels in this manner. To tear a few sheets of toilet tissue or paper towels from the remainder of the roll typically requires two hands: one hand to hold the free end of the roll and one hand to hold the remainder of the roll. Requiring two hands to tear a sheet from a roll, especially in the circumstances where these types of sheets are most desired, is inconvenient.

Some sheet roll dispensers are known to include a case that supports the roll of sheet roll material and a device to facilitate tearing a lead end of the sheet roll material from the remainder of the roll. For example, it is known to employ a serrated edge adjacent a mouth of the case so that when the lead end of the sheet roll material is pulled against the serrated edge, the lead end of the material disengages from the remainder of the sheet roll material. Other types of devices for tearing sheet roll material include sandpaper-like roughened surfaces that grip the sheet roll material. These known serrated edges and sandpaper-like edges tend to destroy the material to be restrained and are uncomfortable to the touch.

Many bathrooms and water closets in the United States typically stock dry toilet paper and moistened toilet paper. Although not related to the aforementioned problems regarding tearing sheets of paper towels or toilet paper, stocking two types of toilet paper requires the consumer to purchase two different consumer packaged goods. Moreover, if the moistened toilet paper, or wipes, are not used before the moistening agent has evaporated, the consumer is left with a dry piece of toilet paper, or wipe, when a moistened piece was desired.

### SUMMARY

An example of a sheet roll dispenser that can overcome some or all of the aforementioned shortcomings includes a roll carrier, an outlet-side mouth and a restraining device. The roll carrier is configured to support an associated roll of fibrous sanitary tissue product, e.g. a roll of paper towels or a roll of toilet paper, and to allow the associated roll to rotate with respect to the roll carrier to dispense sheet roll material from the associated roll when a free end of the associated roll is drawn in a drawing direction. The outlet-side mouth is connected with the roll carrier. The restraining device is on the mouth and includes a plurality of flexible fibers having distal ends defining a fiber tip curve.

An example of a method for dispensing sheet roll material that can overcome some of the aforementioned shortcomings includes placing a roll of fibrous sanitary tissue product having perforations in a sheet roll dispenser including fibers having distal ends that define a fiber tip curve. The method further includes drawing the fibrous sanitary tissue product over the plurality of fibers in a first drawing direction. The method further includes drawing the fibrous sanitary tissue product over the plurality of fibers in a second drawing direction. The first drawing direction is generally co-extensive with a tangent line that intersects an initial contact point of the fiber tip curve or is angularly offset from the tangent line away from the distal ends of the fibers located beyond the initial contact point in the first drawing direction. The initial contact point of the fiber tip curve is where the fibrous sanitary tissue product first contacts the fibers in the first drawing direction. The second drawing direction is angularly offset away from the tangent line at the initial contact point toward the distal ends of the fibers located beyond the initial contact point in the first drawing direction.

An example of another sheet roll dispenser that can overcome at least some of the aforementioned shortcomings includes a roll carrier and a fluid dispenser. The roll carrier is configured to support an associated roll of fibrous sheet roll material. The roll carrier includes a mouth and a fluid dispenser receptacle. The mouth includes an external surface over which sheet roll material from the associated roll is drawn to be dispensed from the roll carrier and an internal surface that defines a boundary of the fluid dispenser receptacle. The fluid dispenser is disposed in the fluid dispenser receptacle and includes a container for holding fluid. The container has a configuration that substantially matches the internal surface of the fluid dispenser receptacle.

### BRIEF DESCRIPTION OF THE DRAWINGS

FIG. 1 is a front perspective view of a sheet roll dispenser.

FIG. 2 is a front perspective view of an alternative embodiment of a sheet roll dispenser.

FIG. 3 is a front cross-sectional view of the sheet roll dispenser shown in FIG. 1.

FIG. 4 depicts the sheet roll dispenser of FIG. 1 inserted into a wall and a door of the dispenser opened.

FIG. 5 is a cross-sectional view of an unwinding assembly of the sheet roll dispenser of FIG. 1 with a battery compartment and a retainer removed from a roller.

FIG. 6 is a cross-sectional view taken along line 6-6 in FIG. 5.

FIG. 7 is a side cross-sectional view of the dispenser of FIG. 1 taken in a plane normal to a rotational axis of a roller of the dispenser.

FIG. 8 is a side cross-sectional view of a lower portion of a sheet roll dispenser including a movable flap for covering a discharge slot of the dispenser.

FIG. 9 is a side cross-sectional view of the dispenser including a peeler.

FIG. 10 is a side cross-sectional view of the dispenser including an alternative embodiment of a peeler.

FIG. 11 is a side cross-sectional view of the dispenser including another alternative embodiment of a peeler.

FIG. 12 is a front cross-sectional view of the dispenser including a sheet roll urging device of the dispenser.

FIG. 13 is a side cross-sectional view of the dispenser including an alternative embodiment of a sheet roll urging device.

FIG. 14 is a side cross-sectional view of the dispenser including an alternative embodiment of a sheet roll urging device.

FIG. 15 is a side cross-sectional view of the dispenser including another alternative embodiment of a sheet roll urging device.

FIG. 16 is a front elevation view of the sheet roll urging device shown in FIG. 15.

FIG. 17 is a side cross-sectional view of the dispenser including an alternative embodiment of a sheet roll urging device.

FIG. 18 is a front elevation view of the sheet roll urging device shown in FIG. 17.

FIG. 19 is a perspective view of another embodiment of a sheet roll dispenser and a roll of toilet tissue disposed in the sheet roll dispenser.

FIG. 20 is an end view of the sheet roll dispenser and toilet tissue shown in FIG. 19.

FIG. 21 is a side elevation view of a fluid dispenser used with the sheet roll dispenser shown in FIGS. 19 and 20.

FIG. 22 is a schematic cross-sectional view of a restraining device on a mouth of the sheet roll dispenser shown in FIG. 19.

FIG. 22A is a close-up view of a radial flexible finger of the restraining device shown in FIG. 22.

FIG. 23 is a schematic cross-sectional view of the restraining device on the mouth of the sheet roll dispenser shown in FIG. 19 cooperating with a piece of sheet roll material being drawn in a first drawing direction.

FIG. 24 is a schematic cross-sectional view of the restraining device on the mouth of the sheet roll dispenser shown in FIG. 19 cooperating with a piece of sheet roll material also being drawn in another first drawing direction

FIG. 25 is a schematic cross-sectional view of the restraining device on the mouth of the sheet roll dispenser shown in FIG. 19 cooperating with the sheet roll material being drawn in a second drawing direction.

FIG. 26 is a perspective view of another alternative embodiment of a sheet roll dispenser and a roll of toilet tissue disposed in the sheet roll dispenser.

FIG. 27 is an end view of the sheet roll dispenser shown in FIG. 26.

### DETAILED DESCRIPTION

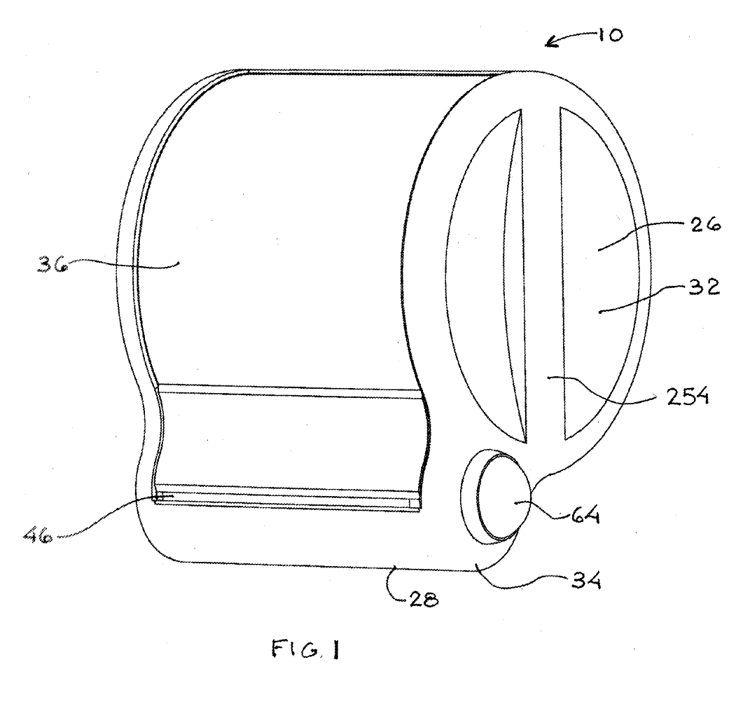

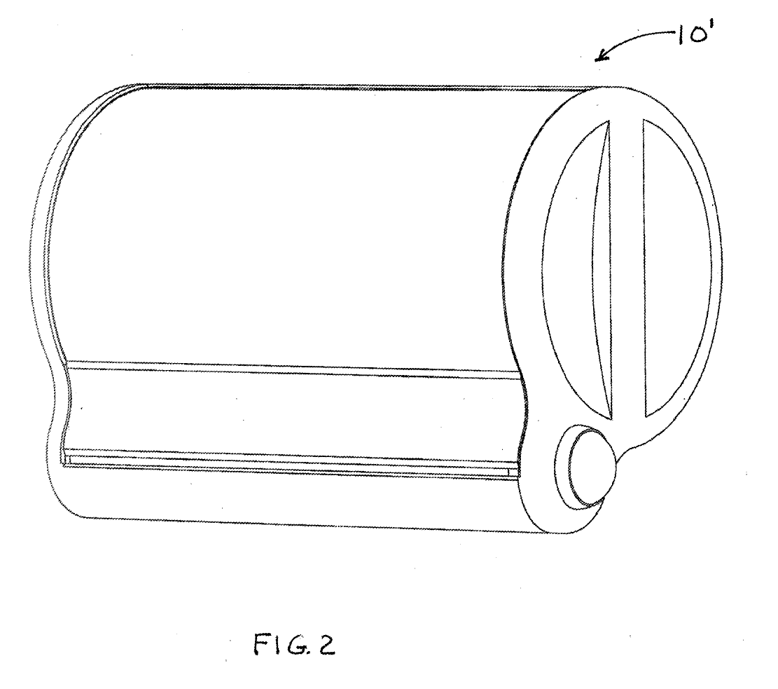

With reference to FIG. 1, a sheet roll dispenser 10 is shown in a configuration suitable for dispensing a roll of toilet tissue. The sheet roll dispenser 10 includes a case 12 that is configured to receive an associated sheet roll, which is in this embodiment is the roll of toilet tissue. With reference to FIG. 2, an alternative embodiment of a sheet roll dispenser 10′ is shown where the sheet roll dispenser is configured to dispense a roll of paper towels. The components of each dispenser are the same with the exception of the size of the some of the components. Accordingly, the smaller sheet roll dispenser 10 will be described with particularity with the understanding that changing the size of the components in the smaller sheet roll dispenser 10 will result in a sheet roll dispenser 10′ that can accommodate paper towels.

As more clearly seen in FIG. 3, the sheet roll dispenser 10 includes a case 12, a roller 14 disposed in the case, a motor 16 disposed inside the roller 14, a battery compartment 18 disposed inside the roller 14, and electrical contacts 22 disposed within the battery compartment. The internal components can be located elsewhere in the case 12; however, the locations shown in FIG. 3 provide for a compact dispenser. The roller 14 is for unwinding a sheet roll TP, e.g. toilet tissue, paper towels, etc., from the case 12. The motor 16 operatively engages the roller 14 to rotate the roller to unwind the sheet roll TP. The battery compartment receives batteries B, which in the depicted embodiment are AA batteries, AAA batteries, or other similar type power source. The electrical contacts electrically connect the motor 16 with the batteries B for supplying electrical current from the batteries B to the motor.

The case 12 provides a neat and sanitary device by protecting the unused sheet roll inside the case. The case provides a stylish look that hides the white roll of toilet paper in a person's bathroom or the white roll of paper towels in a person's kitchen. The case 12 in the depicted embodiment is formed having end walls 24 and 26 interconnected by a central section 28. As more clearly seen in FIG. 1, each end wall 24 and 26 (only end wail 26 being visible in FIG. 1) includes a substantially circular larger upper section 32 and a smaller lower forward section 34 having a lower portion that generally follows the circumference of a circle. The larger upper section 32 is slightly larger than the axial end of the sheet roll TP received in the case 12. The smaller lower section 34 is sized to accommodate an unwinding assembly, which includes the motor 16 and battery compartment 18. The end walls 24 and 26 are axially spaced from one another, with respect to a rotational axis of the sheet roll TP, to receive the sheet roll. Where the dispenser is configured to receive a larger sheet roll, e.g. a paper towel (see FIG. 2), the end walls 24 and 26 are further axially spaced from one another and the central section 28 is longer.

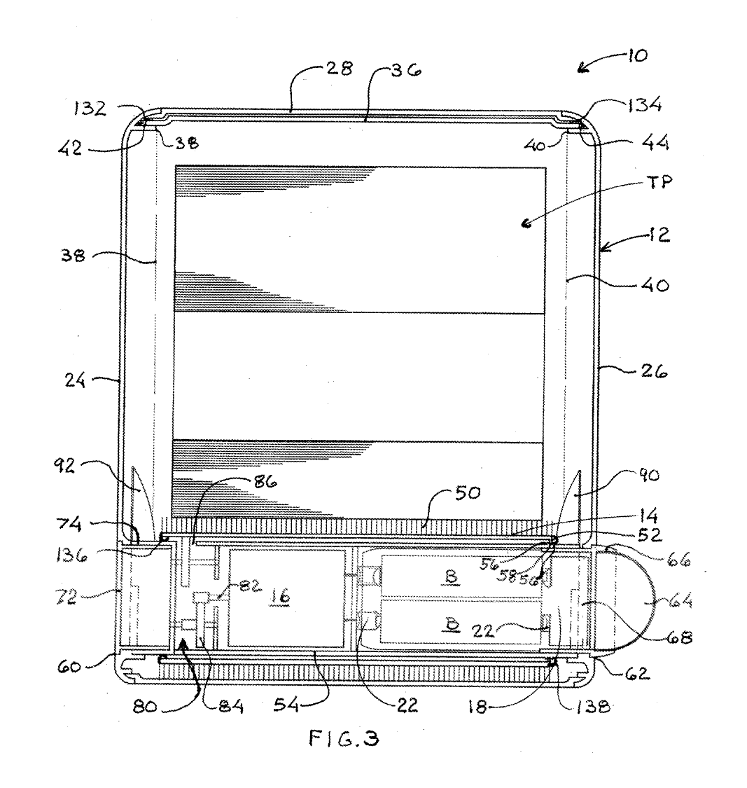

A movable door 36 connects to the case 12. In the depicted embodiment the door 36 is slidable between an open position (FIG. 4) and a closed position (FIGS. 1 and 2). In the depicted embodiment, the door 36 retracts into the case 12 when moving from the closed position (FIG. 1) towards the open position (FIG. 4). The door 36 is contoured to follow the contour of the end walls 32 and 34 of the case to complement the curvature of the respective upper and lower sections of each end wall of the case. Accordingly, one section of the door generally follows the circumference of the circle that approximates the upper section 32 and a lower second section of the door generally follows the circumference of the circle that approximates the lower section 34.

With reference to FIG. 3, extension pairs 38 and 40 are formed on internal surfaces of respective end walls 24 and 26. The extension pairs 38 and 40 extend inwardly into the case and each define a notch 42 and 44, respectively, that receives a respective edge of the slidable door 36. With reference to FIG. 4, the door 36 retracts into the case 12 so that the sheet roll TP can be inserted into the case. Embodiments of the dispenser 10 can be referred to as “spindleless” which allows the sheet roll to be easily inserted into the case because no spindle needs to be inserted through the core of the sheet roll TP. With reference back to FIG. 1, when the door 36 is in the closed position, the case 12 and the door 36 define a discharge slot 46 for the sheet roll TP to exit the case.

With reference back to FIG. 3, a plurality of radial flexible fingers 50 extend from an outer surface of the roller. In the depicted embodiment, each flexible finger 50 is made from a fiber material (similar to a conventional cylindrical brush) and substantially aligns with a radius emanating from a rotational axis of the roller 14 (see FIG. 6). By providing flexible fingers 50 that are aligned with a radius of the roller, the fingers 50 can easily deflect to grab the sheet roll and advance the sheet roll towards the discharge slot 46 (FIG. 1). The radially aligned flexible fingers also grab the sheet roll and retain the sheet roll against the fingers 50 and the case 12 or door 36 when an operator of the dispenser tears sheets of the sheet roll free. This will be described in more detail below. The radial fibers 50 in the depicted embodiment provide an advantageous mechanism for engaging the sheet roll TP to dispense the sheet roll from the case 12; however, other flexible material that can grab porous tissue and slide smoothly across plastic can also be used to engage and deploy the sheet roll TP.

The roller 14 also includes a circular flange 52, which locates the roller inside the case 12 in a manner that will be described in more detail below. In the depicted embodiment, the flange 52 is located at one end of the roller and extends inwardly towards the rotational axis of the roller.

In the depicted embodiment, the roller 14 is cylindrical and hollow. A cylindrical power drive housing 54 is received inside the roller 14. The power drive housing 54 provides a location to mount the drive components of the unwinding assembly for the dispenser. In the depicted embodiment, the power drive housing 54 includes annular ridges 56 that define a circular notch 58 that receives the circular flange 52 of the roller 14 and provides a slip bearing so that the roller 14 rotates with respect to the power drive housing 54.

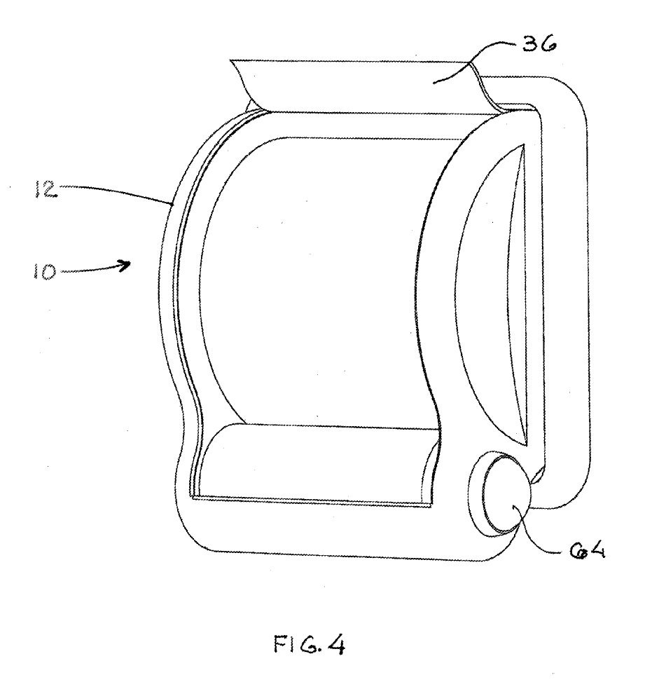

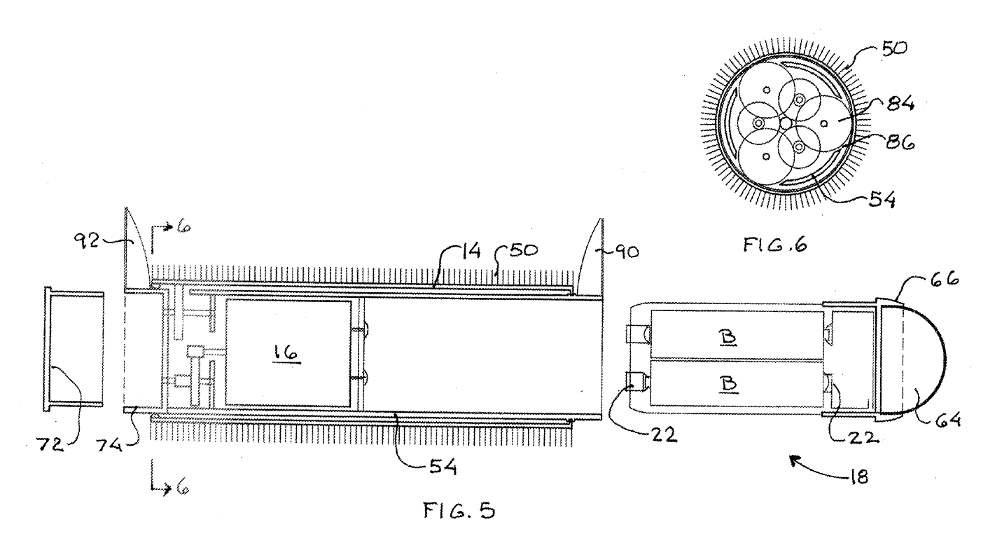

The motor 16 and the battery compartment 18 are received inside the power drive housing 54, and thus inside the roller 14. As more clearly seen in FIG. 5, the battery compartment 18 is removable from the power drive housing 54. With reference back to FIG. 3, the end walls 24 and 26 of the case 12 each include a respective opening 60 and 62. The openings 60 and 62, in the depicted embodiment, are circular and aligned, e.g. coaxial, with one another. The battery compartment 18 is removable from and insertable into each opening 60 and 62. This allows the dispenser to be operated in a left-hand and a right-hand configuration.

With reference back to FIG. 3, a switch button assembly, which includes a switch button 64 and a switch button retainer 66, connects to the battery compartment 18. The switch button 64 operates a switch 68 (depicted schematically in FIG. 3) that is electrically connected with the electrical contacts 22. In the depicted embodiment, the switch button retainer 66 is circular and is configured to be received inside either opening 60 or 62 in either end wall 24 or 26 of the case 12. The openings 60 and 62 provide at least two mounting locations for the switch button retainer 66 and the switch button 64 on opposite sides of the case 12 to provide a left-hand configuration and a right-hand configuration for the dispenser 10. The switch button assembly connects to the case 12 via a friction or resilient fit once inserted into the appropriate opening 60 or 62. By engaging the power drive housing 54, which supports the roller 14, the switch button assembly also supports the roller 14 inside the case.

A retainer 72 is configured to retain the roller 14 in the case 12. More particularly, the retainer 72 supports an opposite end of the power drive housing 54 as the switch button assembly. The retainer 72 is generally cylindrical so that it can be received in either opening 60 or 62 in either end wall 24 or 26 of the case 12. In the depicted embodiment, the retainer 72 is received inside a generally cylindrical insert 74 that connects to an end of the power drive housing 54 opposite the end to which the switch button assembly is attached. To remove the unwinding assembly, which includes the motor 16, the battery compartment 18 and other components that will be described in more detail below, one removes the battery compartment 18 from opening 62 and the retainer 72 from opening 60. The operator then reaches into the case through the opening provided when the door 36 is in the open position (FIG. 4) and removes the roller 14 with the motor 16 still disposed inside the roller. The roller 14 can then be rotated about an axis perpendicular to its rotational axis, which would result in the motor being disposed on a right side of the dispenser 10 (as compared to being disposed on the left side shown in FIG. 3). The batteries B can be flipped to change the direction of current being delivered to the motor 16 and then the battery compartment 18 can be inserted into the power drive housing 54 through the opening 60 and the retainer can be received in opening 62 to retain the roller inside the case. By providing a dispenser that can operate in both a right-hand and a left-hand configuration, the number of mounting locations where the dispenser 10 can be located inside one's home or office are increased because access can be provided from either side of the case 12. This is particularly desirable where the dispenser 10 is mounted in a recess in a wall (see FIG. 4).

With reference to FIG. 3, the electrically driven unwinding assembly includes the motor 16 operatively engaging the roller 14 via a transmission 80. An output shaft 82 of the motor 16 engages plastic or rubber-like compression rollers 84 in the depicted embodiment, as opposed to gears, to provide a quiet transmission. The compression rollers 84 that make up the transmission 80 shown in FIG. 3 is a type of speed reduction transmission from the higher speed motor 16 to a slower but more forceful output where the compression rollers 84 engage an inner surface of the roller 14 (see FIG. 6). The power drive housing 54 includes slots 86 and components of the transmission 80, more particularly the compression rollers 84 at the output end of the transmission, extend through the slots to engage the roller 14 (see also FIG. 6).

In the depicted embodiment, the moving components of the unwinding assembly are found in the roller 14. Additionally, the electrical components of the unwinding assembly are also found in the roller 14. This provides for a compact dispenser having a quiet operation and a robust packaging. Placing the motor and the battery compartment inside the roller utilizes this valuable space to minimize the overall footprint of the dispenser 10. The transmission assembly described above can employ gears or other types of mechanisms known in the art to drive the roller; however, the quiet operation of the transmission may be sacrificed by replacing the compression rollers.

With reference back to FIG. 5, fenders 90 and 92 are also provided in the case. The first fender 90 extends upwardly from an end of the power drive housing 54 that receives the battery compartment 18 and the switch button retainer 66. The second fender 92 extends upwardly into the case from the insert 74 that connects to the opposite end of the power drive housing 54 with respect to the switch button assembly. The fenders 90 and 92 axially align the sheet roll TP inside the case 12.

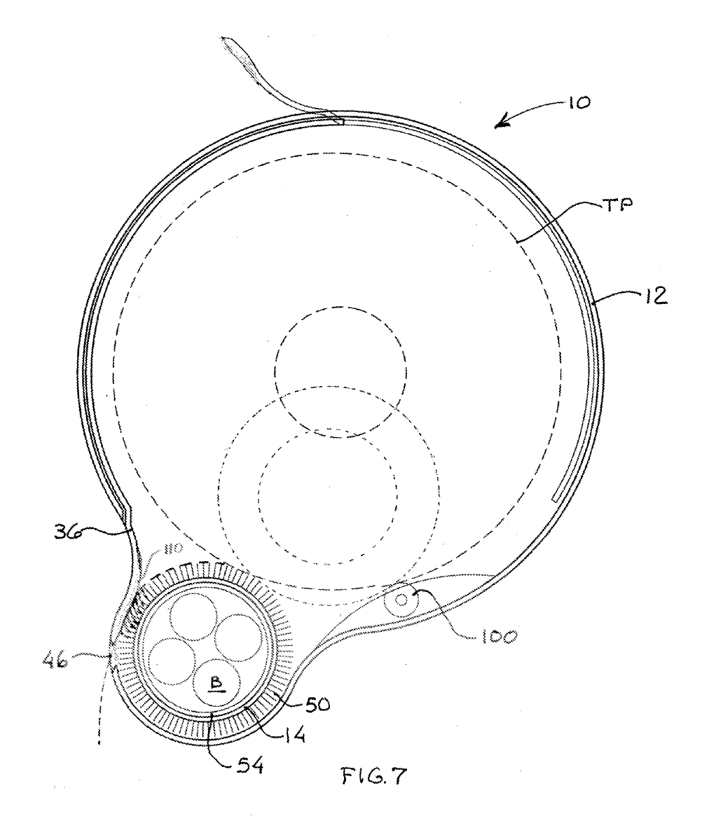

With reference to FIG. 7, in the depicted embodiment, in addition to the roller 14 a support 100 is also provided in the case 12 to support the sheet roll TP. In the depicted embodiment, the support 100 is an additional smaller roller. The rotational axis of the sheet roll TP is equidistant from a location where the sheet roll engages the support 100 and a location where the sheet roll engages the roller 14. This allows the sheet roll to be centered between the roller 14 and the support 100. The support 100 and the roller 14 also support the sheet roll TP from the case 12 spacing the sheet roll from the case to reduce any friction that may result from the sheet roll contacting the case as the sheet roll TP is being dispensed from the dispenser. The support 100 is shown as a roller in FIG. 7; however, multiple rollers can be provided or other friction reducing members such as small protuberances extending upwardly from the case to limit the contact area between the sheet roll and the case.

With continued reference to FIG. 7 operation of the dispenser 10 will be further explained. As explained above, embodiments of the dispenser can be referred to as “spindleless” in that a spindle is not used to support the sheet roll TP inside the case 12. This eases loading of the sheet roll inside the case. An operator opens the door 36 by retracting the door 36 into the case 12 and inserts the sheet roll TP into the case so that the sheet roll is supported by the roller 14 and the support 100. The operator then pulls the free end of the sheet roll and extends it outwardly from the case 12 and closes the door 36 so that the free end of the sheet roll extends through the discharge slot 46. The inner surface of the door 36 is formed to deflect the radial fingers 50 that extend outwardly from the roller 14 to retain the sheet roll against the deflected fingers and the door. In the depicted embodiment, the door 36 is formed including protuberance 110 that urges the distal ends of friction fingers 50 in a direction counter to the direction in which the roller 14 rotates to dispense the sheet roll TP. As seen in FIG. 7, with the radial flexible fingers having their distal ends bent in a clockwise direction with respect to their proximal end, the flexible fingers 50 operate as a type of ratchet device so that when the operator of the dispenser 10 pulls the free end of the sheet roll TP, the radial fingers 50 in cooperation with the door 36 (and protuberance 110) grab the sheet roll so that sheets from the sheet roll can be easily torn from the remainder of the sheet roll in the case. This provides an easy one hand operation, e.g. same hand that operates the switch button 64 to dispense the sheet roll can also be the same hand that is used to tear the sheet roll.

The sheet roll dispenser that has been described above can include alternative or additional components and is not limited to only the aforementioned components. Some additional components and alternative embodiments of the dispenser will be described in more detail below. The invention, however, is not limited to only the alternatives and additional components that are described below.

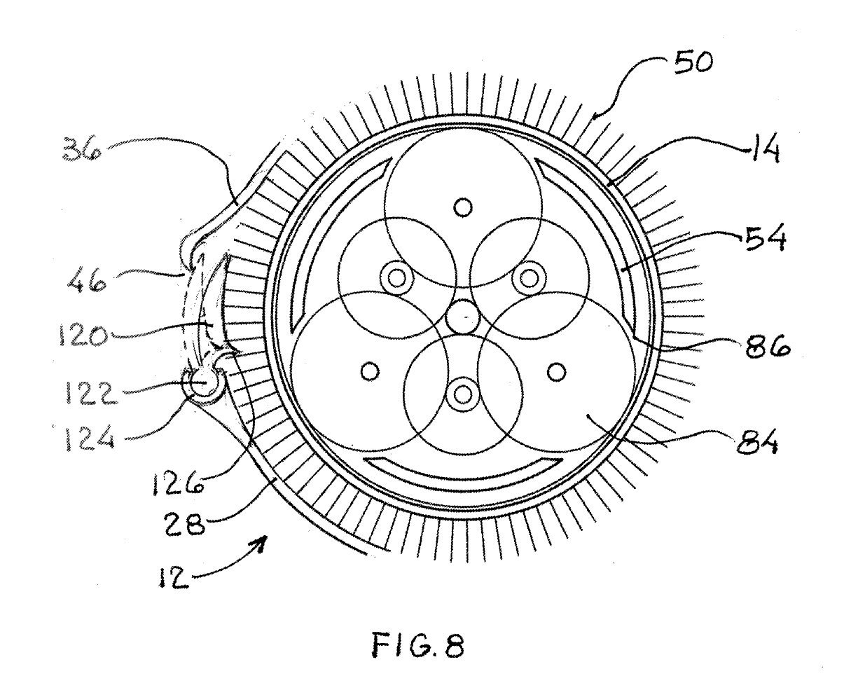

In addition to dispensing conventional dry toilet tissue and paper towels, the sheet roll dispenser can also be used to dispense moist tissue and the like. Where the dispenser is used to dispense moist material, it can be desirable to provide a movable flap 120 (FIG. 8) for covering the discharge slot 46. In an embodiment that includes the movable flap 120, the flap is movable between an open position (shown in solid lines in FIG. 8) and a closed position (shown in phantom in FIG. 8).

In the embodiment depicted in FIG. 8, the movable flap 120 includes an integrally formed cylindrical section 122 that is received in a socket 124 formed at an end of the central section 28 of the case 12. A cam 126, which in the depicted embodiment is integrally formed with the flap 120, cooperates with the movable flap and the flexible fingers 50 extending from the roller 14 to move the flap from the closed position towards the opened position. When the roller 14 is rotating in a direction to dispense material from the dispenser (counterclockwise in FIG. 8) the movable flap 120 moves from the closed position to the opened position due to the fingers 50 contacting the cam 126. The movable flap 120 can be biased back towards the closed position by a spring (not shown). Alternatively, a controller can be provided in the unwinding assembly (in the battery compartment 18) to allow the motor 16 to rotate in two different rotational directions. The controller can be configured to deliver current to the motor in the direction opposite the unwinding direction (clockwise in FIG. 8) after the switch button 64 has been released to close the discharge slot 46 by moving the movable flap 120 towards the door 36. The controller can also be configured to count rotations of the roller for measuring the length of sheet roll material being dispensed from the sheet roll to control the length of material that is dispensed. The controller can also be configured to work with other components (mechanical or electrical) to respond to features on the sheet roll, e.g. detect perforations in the sheet roll. Examples of these other components include an optical sensor and a mechanical feeler that moves when riding over a perforation.

Where the dispenser 10 is used to dispense moist sheet roll material, seals can also be provided for sealing the internal compartment of the case 12 to mitigate evaporation. With reference back to FIG. 3, seals 132 and 134 can be provided in respective notches 42 and 44. The seals contact the door 36 and the case 12 for sealing the internal compartment of the case. Additionally, seals 136 and 138 can be provided where the switch button assembly contacts the power drive housing 54 to prevent the ingress of moisture into the battery compartment 18.

The sheet roll dispenser 10 described above can also include a peeler to direct the sheet roll towards the discharge slot 46. More particularly, the peeler can engage a free end of the sheet roll TP to direct the sheet roll toward the discharge slot 46 of the dispenser. With reference to FIG. 9, an example of a peeler 140 that includes a blade 142 that is biased toward the sheet roll TP is shown. In this embodiment, the peeler 140 mounts to each fender 90 and 92 (see FIG. 3—only fender 90 is visible in FIG. 9). The peeler includes arms 144 (only one visible in FIG. 9—another similarly shaped arm would attach to the fender 92 on the other side of the dispenser). The blade 142 attaches to each arm 144 (and the other arm attached to the other fender 92). Each arm 144 includes a pin 146 that attaches to the fender 90 (the other arm includes a pin also). As mentioned above, the peeler 140 is biased towards the sheet roll TP. In the depicted embodiment a torsion spring 148 acts against the fender 90 and the arm 144 (an additional torsion spring can be provided on the other side of the peeler 140) to bias the blade 142 toward the sheet roll TP.

The sheet roll TP is loaded into the case 12. The roller 14 rotates in a clockwise direction resulting in the sheet roll TP rotating in a counterclockwise direction. The peeler blade 142 engages a free end of the sheet roll TP to direct the free end of the sheet roll toward the discharge slot 46.

With reference to FIG. 10, an alternative embodiment of a peeler that engages a free end of the sheet roll TP to direct the sheet roll toward the discharge slot 46 of the dispenser is shown. In this embodiment, the peeler 160 includes a blade 162 that is urged toward the sheet roll TP by the weight of the sheet roll. The peeler 160 includes an arm 164 and the blade 162 is at an end of the arm. An additional arm (not visible in FIG. 10) is disposed at an opposite axial end of the sheet roll TP. Each arm 164 (only one visible in FIG. 10) attaches to a respective end wall 24 and 26 (FIG. 3) of the case 12 via a pivot pin 166. In this embodiment, the additional roller 100 also connects to each arm 164 (the other arm not being visible in FIG. 10). The peeler 160 pivots about the pivot pin 166 (and the other pivot pin that connects the other arm on an opposite side of the sheet roll TP). The downward force of the weight of the sheet roll TP on the support 10.0 results in the blade 162 moving towards the sheet roll TP to engage a free end of the sheet roll and urge the free end toward the roller 14 and thus toward the discharge slot 46. In the embodiment shown in FIG. 10, the roller 14 rotates in a clockwise direction and the sheet roll TP rotates in a counterclockwise direction so that a free end of the sheet roll TP would engage the blade 162 and be directed toward the roller 14.

With reference to FIG. 11, an additional embodiment of a peeler 170 that includes a peeler roller 172 that catches a free end of the sheet roll TP to direct the free end towards the discharge slot 46 of the dispenser 10 is shown. In this embodiment, the roller 172 rotates about an axle 174. A tension spring 176 is attached at one end to the axle 174 and at an opposite end a bracket 178 attached to the unwinder assembly. The tension spring 176 urges the peeler roller 172 against both the roller 14 and the sheet roll TP. The peeler roller 172 directs the free end of the sheet roll TP towards the roller 14 and thus towards the discharge slot 38. In this embodiment, the roller 14 rotates in a clockwise direction and the sheet roll TP rotates in a counterclockwise direction.

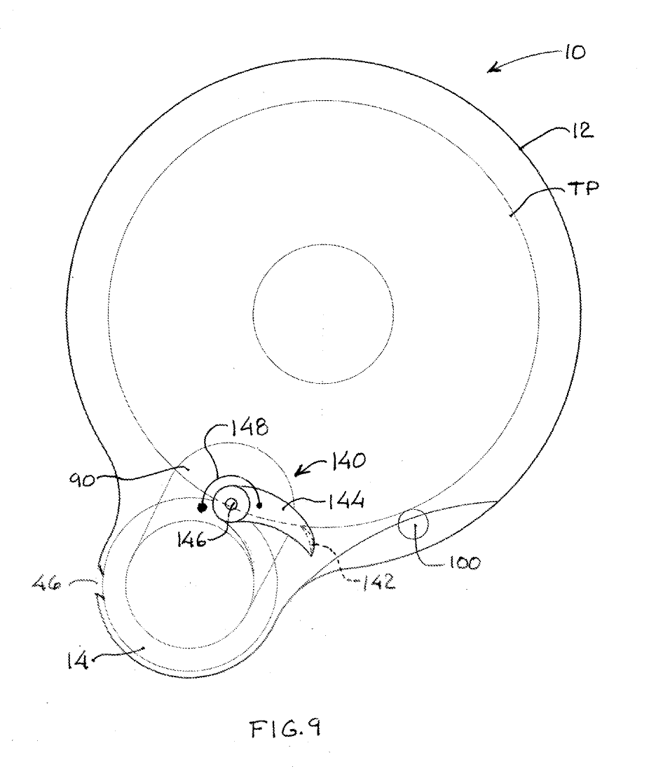

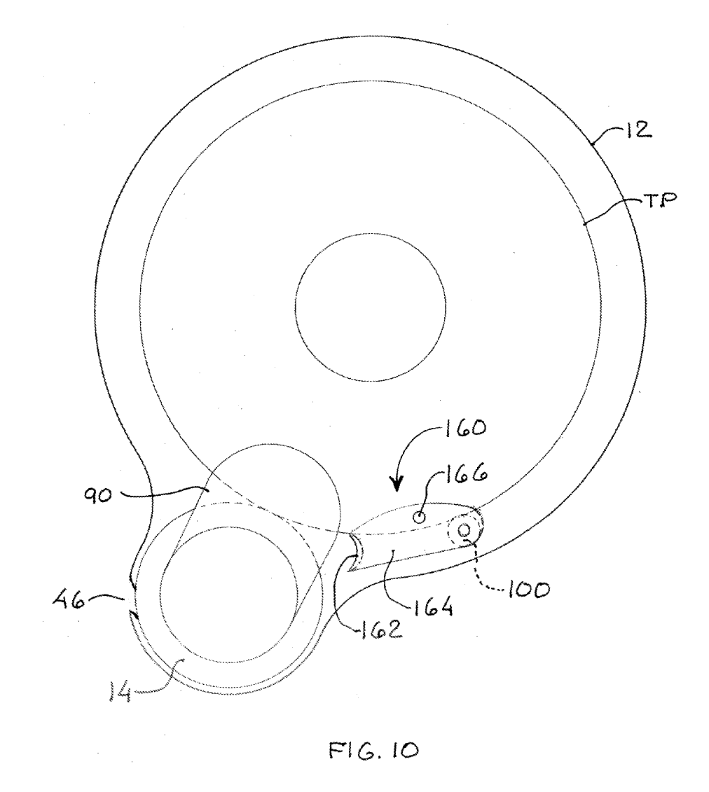

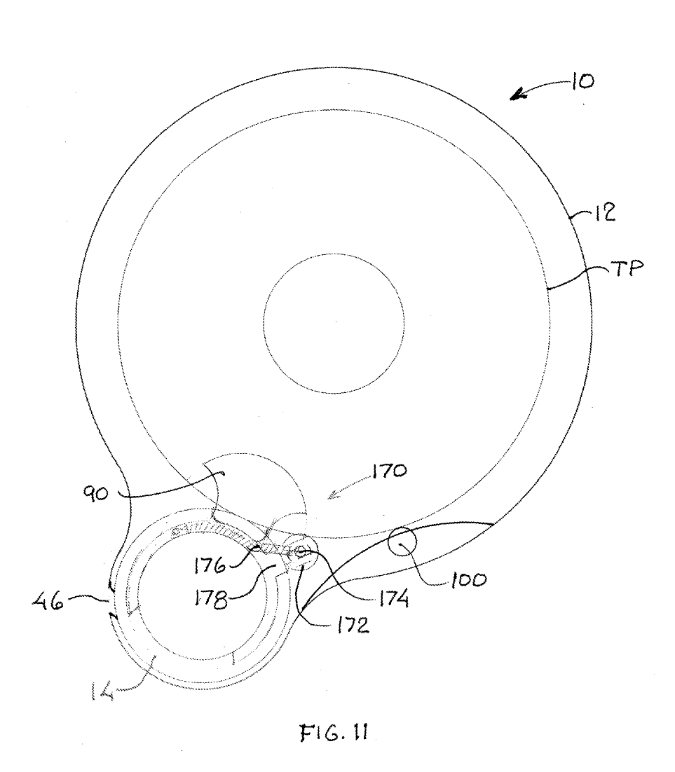

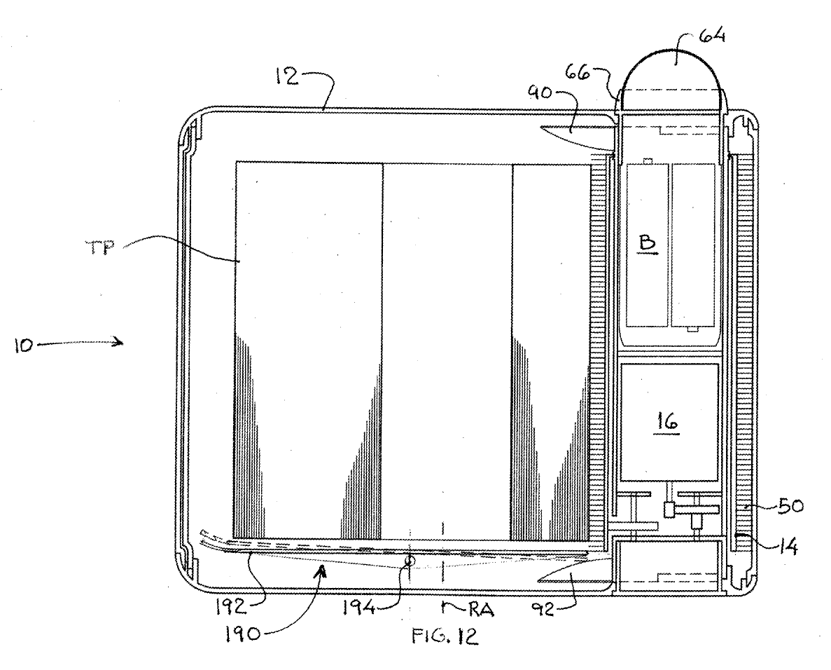

With reference to FIG. 12, the sheet roll dispenser 10 can include a sheet roll urging device in the case 12 for urging the sheet roll TP towards the roller. This allows the dispenser to be oriented in a vertical orientation (as opposed to the horizontal orientation depicted in FIGS. 1 and 2). For example, by providing the sheet roll dispenser 10′ in FIG. 2 in a vertical orientation, the sheet roll dispenser can be placed on the countertop of a kitchen or similar location. Likewise, the dispenser 10 shown in FIG. 1 can be placed on a bathroom vanity to dispense toilet tissue.

With reference to FIG. 12, a sheet roll urging device 190 includes a table 192 supported by an axle 194 connected to the case 12. The axle 194 is offset from a rotational axis RA of the sheet roll TP in a direction away from the roller 14. When the sheet roll TP is loaded into the case in a vertical direction, because of the axle 194 being offset from the central axis of the sheet roll TP, the table 192 pivots to urge the sheet roll towards the roller 14. The table 192 is made from a smooth plastic material which allows an axial end of the sheet roll TP to easily slide along the table with very little frictional forces so that as the roller 14 rotates to dispense the sheet roll material, minimal frictional forces need to be overcome as the sheet roll rotates on the table.

With reference to FIG. 13 an alternative embodiment of a sheet roll urging device 200 is disclosed. In this embodiment, the sheet roll urging device 200 includes spring arms 202 (only one visible in FIG. 13) that are disposed in the case 12 of the dispenser 10 on opposite axial ends of the sheet roll TP. The spring arms 202 are biased to pivot about a pin 204 that connects each spring arm to the case 12 and more particularly to the end walls 24 and 26 of the case. An urging roller 206 attaches to an end of each spring arm opposite the end that attaches to the case. The spring arms 202 (only one visible in FIG. 13) and the roller 206 urge the sheet roll TP towards the roller 14. Since the spring arm 202 is biased in the generally clockwise direction shown in FIG. 13, the roller 206 engages the sheet roll TP as the sheet roll is being depleted inside the case 12. A cam 208 is provided on the door 36 to engage the spring arm 202 to move the urging roller 206 away from the roller 14 as the door is opened into the retracted position. This allows the sheet roll TP to be loaded into the case while the urging roller 206 is away to provide access to the case.

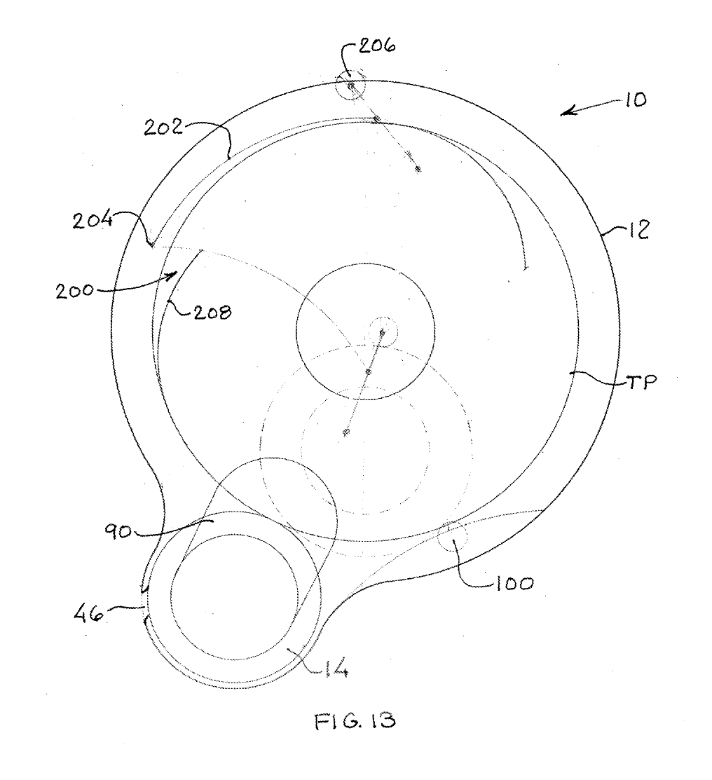

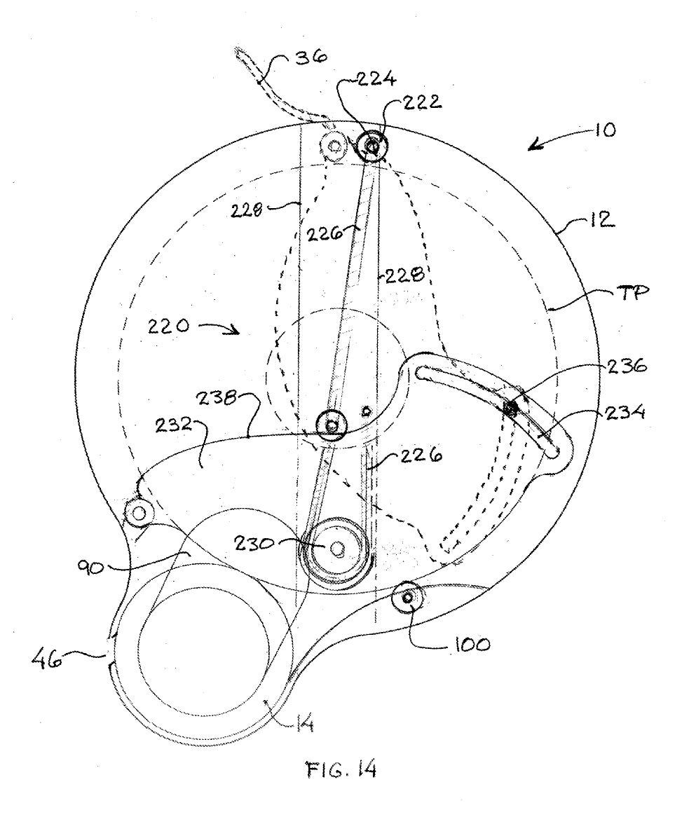

FIG. 14 discloses a sheet roll urging device 220 in the case 12 of the dispenser 10 that includes a biased wheel 222 that engages the sheet roll TP. The biased wheel 222 rotates about an axle 224 that is received within a slide notch 228 formed in each end wall 24 and 26 (FIG. 3) of the case 12. The roller 222 is biased by a tension spring 226 that is wrapped around a pulley 230 connected to the case 12. The biased spring 226 is connected at one end to the case 12 and at another end to the axle 224 about which the wheel 222 rotates. A cam 232 attaches to and is movable with the door 36. The cam 232 includes a curved slot 234 that receives a pin 236 attached to the case 12 and more particularly to an end wall 24 or 26 of the case. The pin 236 slides in the slot 234 as the cam moves. The cam 232 includes a curved cam surface 238 that engages the axle 224 about which the wheel 222 rotates. When the door 36 is moved from the closed position to the opened position the cam surface 238 of the cam 232 engages the axle 224 against the biasing force of the tension spring 226 to move the wheel 222 away from the roller 14. This allows the sheet roll TP to be inserted into the case 12.

With reference to FIGS. 15 and 16, an alternative embodiment of a sheet roll urging device 250 that includes a biased hub 252 configured to be received in a core C of the associated sheet roll TP is disclosed. The hub 252 is biased toward the roller 14. As more clearly seen in FIG. 1, each side wall 26 of the case 12 includes a channel 254 that bisects the substantially larger circular section 32 of each side wall (only one visible in FIG. 1). The hub 252 rides within this channel. The hub 252 connects to a pin 256 that rides along a door cam surface 258 formed along the door 36. With the pin 256 attached to the hub 252 as the pin 256 rides along the cam surface 258 the hub 252 can move out of the way to allow the user of the dispenser 10 to insert the sheet roll TP into the case 12. With reference to FIG. 16, the hub 252 attaches to a pin 262 that rides in a curved notch 264. An upper end of the curved notch 264 bends outwardly toward the channel 254 to move the hub 252 axially away from the core C of the sheet roll TP when the door 36 is in the open position. The hub 252 is biased downwardly by a spring (not shown) toward the roller 14 so that as the sheet roll is dispensed, the sheet roll is urged toward the roller 14.

With reference to FIGS. 17 and 18, an alternative embodiment of a sheet roll urging device 270 that includes a biased hub 272 configured to be received in a core C of the associated sheet roll TP is disclosed. The hub 272 is biased toward the roller 14. In the depicted embodiment, the hub 272 attaches to a distal end of an arm 274 that is connected to the case 12 via a pivot pin 276 (see FIG. 18). A spring 280 biases the arm 274 in a counterclockwise direction (per the orientation shown in FIG. 17) to urge the sheet roll TP toward the roller 14. In the depicted embodiment, the spring 280 is a torsion spring including a coil 282, a first leg 284 extending from the coil and attached to the case 12 at a distal end thereof, and a second leg 286 that extends from the coil 282 and attaches at a distal end thereof to the arm 274.

The door 36 includes a flange 290 that extends into the case 12 and a cam 292 extends axially inwardly from the flange 290. The cam 292 contacts the first leg 284 of the spring when moving from a closed position toward an open position to draw the pivoting arm 274 in a clockwise direction (per the orientation of FIG. 17) so that when the door is opened the hub 272 is centered in the case to receive a new sheet roll TP. The sheet roll TP is inserted into the case 12 and the hub 272 is configured to deflect axially outwardly and snap into the core C (see orientation of the hub in FIG. 18). When the door is in the closed position the coil 282 of the spring moves away from the case wall inwardly toward the core which promotes the biasing action of the sheet roll TP toward the roller 14. The pivoting arm 274, the hub 272 and the spring 280 are axially spaced from an end of the sheet roll TP. An additional pivoting arm, hub and spring can be provided on the opposite axial end and act in the same manner as the aforementioned components A flexible connector 278 interconnects the pivoting arm 274 and the additional pivoting arm. The flexible connector 278 allows the arms to spring apart when the sheet roll is installed into the dispenser.

With reference to FIG. 19, an alternative embodiment of a sheet roll dispenser 310 generally includes a roll carrier 312 and a restraining device 314. The roll carrier 312 is configured to support a roll R of fibrous sheet roll material which can include a conventional roll of toilet tissue (shown in FIG. 19) and/or a conventional roll of paper towels. The roll carrier 312 is also configured to support a coreless roll of toilet tissue or paper towels (not shown) and can be easily loaded by simply dropping the roll R into the roll carrier 312. The roll carrier 312 is also configured to allow the roll R to rotate with respect to the roll carrier to dispense sheet roll material from the roll when a free end of the roll is drawn in a drawing direction. The roll carrier 312 can be a plastic integrally molded piece, e.g., made from a one piece construction, to form a case. Alternatively, the roll carrier 312 can be another construction, e.g. a wire support or a metal housing, that is configured to support a roll R of fibrous sheet roll material. As seen in FIGS. 20 and 21, a fluid dispenser 316, which will be described in more detail below, can also be used with the sheet roll dispenser 310 to moisten the dispensed sheets.

The roll carrier 312 depicted in FIGS. 19 and 20 is a case that includes side walls 320 and 322 that are interconnected by a support wall 324. In the embodiment illustrated in FIG. 19, the side walls 320 and 322 are generally planar in configuration and they are spaced from one another in a direction parallel to a rolling, or rotational, axis A of the roll R. The side walls 320 and 322 can be spaced from one another to accommodate a conventional roll of toilet tissue and/or a conventional roll of paper towels. The side walls 320 and 322 restrain axial movement of the roll R.

The support wall 324 that is illustrated in FIG. 1 is generally curved to follow the radius of a conventional roll of toilet tissue and/or a conventional roll of paper towels. The support wall 324 includes a generally smooth internal surface 326 upon which the roll R rests. The internal surface 326 is smooth enough so that the roll R freely rotates on the internal surface 326 as sheets from the roll R are being dispensed from the dispenser 310. If the internal surface 326 is too rough, the roll R can catch as it rotates about the rotational axis A resulting in a leading edge of the roll being unintendedly torn from the remainder of the roll, which can be undesirable. In the illustrated embodiment and as more clearly seen in FIG. 20, in a cross section taken normal to the rotational axis A, the internal surface 326 of the support wall 324 follows a constant radius, which is slightly larger than the radius of a conventional roll of toilet tissue and/or roll of paper towels. The curve of the internal surface, however, can take other configurations, e.g. the curve can have multiple radii.

As more clearly seen in FIG. 20, each side wall 320, 322 (only side wall 320 is visible in FIG. 20; however, side wall 322 has the same configuration) of the roll carrier 312 has a free edge 330, i.e., an edge that is not in contact with the support wall 324. For the illustrated embodiment; when a full roll R of toilet paper or paper towels is placed into the dispenser, the free edge 330 of each side wall 320, 322 that is vertically aligned with the rotational axis A is also disposed vertically below the rotational axis of a full roll. Each side wall 320, 322 illustrated in FIG. 20 can be a generally crescent shape, which can limit the material required to make the roll carrier 312 as compared to known sheet roll dispensers. If desired, a lid (not shown for this embodiment, but similar to the lid 36 in FIG. 1) can be provided to cover the remainder of the sheet roll material and such a lid can retract into the roll carrier generally following the outer circumference of a full roll of conventional toilet tissue and/or roll of paper towels or the curve of the internal surface 326 of the support wall 324.

The sheet roll dispenser 310 also includes a mouth 332 connected with the roll carrier against which sheet roll material from the roll R can be drawn to be dispensed from the case. The mouth 332 is adjacent a sheet roll outlet for the roll carrier 312, and therefore can be referred to as an outlet-side mouth. The mouth 332 can be integrally formed with the remainder of the roll carrier 312 so that the mouth and the roll carrier are formed from one piece of material, e.g., the mouth and the roll carrier are made from a single molded piece of plastic. In the illustrated embodiment, the mouth 332 includes a curved external surface 334 and a curved internal surface 336.

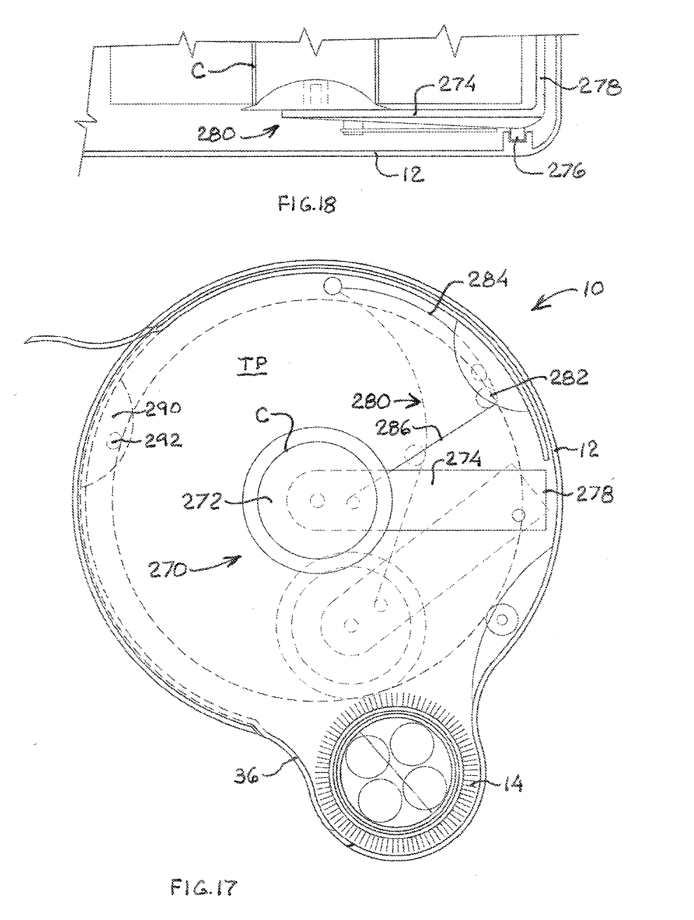

In the depicted embodiment, the restraining device 314 is located on the mouth 332 adjacent a sheet roll outlet 338. More particular to the illustrated embodiment, the restraining device 314 is disposed on the external surface 334 of the mouth 332. The FIGS, depict the restraining device 314 near a lower end of the roll carrier 312 and below the sheet roll outlet 338; however, the restraining device can be located elsewhere on the roll carrier, e.g. above a sheet roll outlet. The sheet roll outlet 338 is an opening or void in the roll carrier that the sheet roll material that is being dispensed from the roll passes through. The sheet roll outlet 338 depicted in FIGS. 19 and 20 is a very large opening, as compared to a sheet roll outlet that will be described in more detail below with respect to FIGS. 26 and 27.

With reference back to the embodiment depicted in FIGS. 1-8, the roller 14 can also be considered as a mouth against which sheet roll material TP can be drawn and dispensed from the case 12. The roller 14 connects with the case 12 and is located adjacent a sheet roll outlet of the case. The plurality of flexible fingers 50 are on the roller 14, or mouth, and operate as a restraining device.

In the depicted embodiment and as more clearly seen in FIG. 22, the restraining device 314 includes a plurality of radially oriented flexible fibers 340. The radially oriented fibers 340 are similar to or the same as the radial flexible fingers 50 described above with reference to FIGS. 1-8. The flexible fibers 340 depicted in FIGS. 22-25 are schematic depictions. As more clearly seen in FIG. 22A, each flexible fiber 340 can be a plurality of filaments 346 that extend from a common opening in a flexible backing 348. The flexible backing material 348 is adhered and/or affixed to the external surface 334 of the mouth 332 and the flexible fibers extend generally perpendicularly from the backing material. Since the backing material 348 is flexible, it can follow the contour of the external surface 334 of the mouth 332.

With reference back to FIG. 22, each flexible fiber 340 includes a proximal end 342 adjacent the external surface 334 of the mouth 332 and a distal end 344 spaced from the proximal end. In the cross section shown in FIG. 22 (taken normal to the rotational axis A), the flexible fibers 340 can align generally perpendicular to a tangent line L (only one tangent line L is depicted in FIG. 22) taken where the central axis for each respective fiber 340 intersects the external surface 334. With reference back to FIG. 8, each radial finger 50 can align generally perpendicular to a tangent line (not shown in FIG. 8) taken where the central axis for each respective finger 50 intersects an external surface of the roller 14.

As seen in FIG. 22, each flexible fiber 340 extends the same length from the flexible backing 348 and the external surface 334 of the mouth 332. In the illustrated embodiment, each fiber 340 extends less than about ¼ in from the flexible backing 348 and there are between about 130 tufts/in² and about 170 tufts/in² (more particularly, 156 tufts/in²). In the cross section taken normal to the rolling axis A (FIG. 20) of the roll R, the distal ends 344 of the flexible fibers 340 define a fiber tip curve 350 (designated by the dashed line in FIG. 22). Each fiber 340 extends generally perpendicular with respect to the external surface 334 of the mouth 332 so that at least a portion of the external surface of the mouth is generally parallel with the fiber tip curve 350. In the illustrated embodiment, the fiber tip curve 350 follows a radius, which can be at least one-quarter of a circle. The fiber tip curve 350, however, can take other configurations, e.g. include more than one radius. With reference back to FIG. 8, distal ends of the plurality of radial finger 50 can also define a fiber tip curve parallel to an external surface of the roller 14, or mouth, and the fiber tip curve in FIG. 8 can follow a radius.

In the illustrated embodiment, the fibers 340 are configured and made from a material, e.g. nylon, that allows the fibers to advantageously interact with a specific type of sheet roll material, which will be referred to as a “fibrous sanitary tissue product.” As used herein “fibrous sanitary tissue product” means a soft, low density (e.g. less than about 0.15 g/cm³) useful as toilet tissue or a paper towel. Unlike the serrated and sandpaper-like edges used to cut a leading end from a paper towel roll or a toilet paper roll, the flexible fibers 340 are very soft to the touch while providing the very useful advantage of restraining the fibrous sanitary tissue product to facilitate tearing the sheets from the roll R. The filaments 346 that make up the tufts can be a monofilament nylon that is 15.3 denier. The filaments 346 can be bundled to 34 filaments per tuft (see for example FIG. 22A). Accordingly, each of the filaments 346 that can make up the radial fibers 340 can be between about 10-20 micrometers in diameter.

With reference to FIG. 23, the fibers 340 are configured to flex toward a direction in which the fibrous sanitary tissue product TP is being drawn. The flexible fingers 50 shown in FIG. 8 operate in the same manner. The fibers 340 are also made from a material and are configured such that when the fibrous sanitary tissue product TP is drawn in a first drawing direction D₁ the fibers deflect away from the fibrous sanitary tissue product TP as the fibrous sanitary tissue product is continuing to be drawn over the fibers in the first drawing direction. This allows a leading end of fibrous sanitary tissue product TP from the roll R to be drawn from the roll without severing the leading end from the remainder of the roll. The first drawing direction D₁ can be generally parallel with respect to a tangent line L (see FIG. 22) intersecting the fiber tip curve 350 at an initial contact point I prior to drawing the fibrous sanitary tissue product in the first drawing direction, e.g. prior to the fibers 340 flexing (see FIG. 22). The initial contact point I is considered where the fibrous sanitary tissue product TP first contacts the fibers 340 as determined in the first drawing direction D₁.

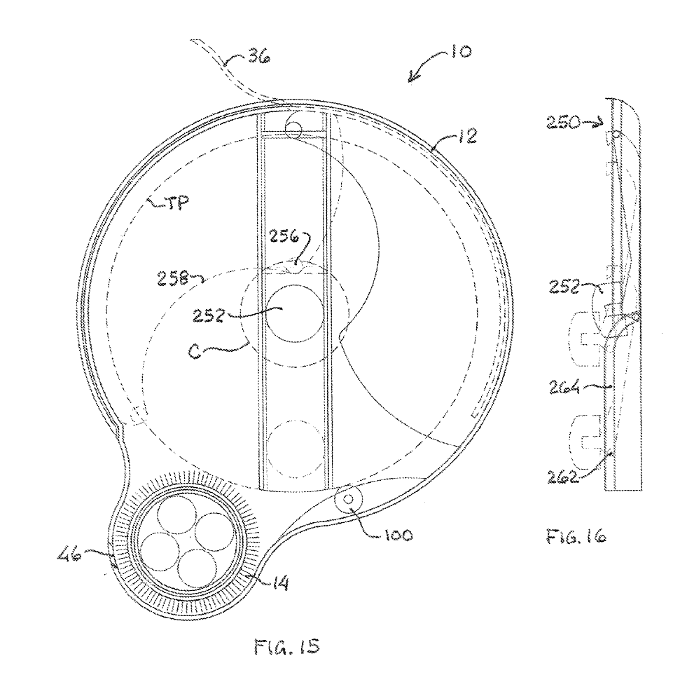

With reference to FIG. 24, the first drawing direction D₁ can also be angularly offset away from the distal ends 344 of the fibers 340 located beyond the initial contact point I in the first drawing direction, e.g. angularly offset upwardly away from the tangent line L per the orientation shown in FIG. 24. So long as the drawing direction of the material riding over the restraining device 314 remains aligned with the first drawing direction D₁, e.g. generally parallel with respect to a tangent line intersecting the fiber tip curve 350 at an initial contact point I or angularly offset away from the distal ends 344 of the fibers 340 located beyond the initial contact point I, then fibrous sanitary tissue product TP can be continued to be dispensed from the roll R without the leading end severing from the remainder of the roll.

The distal ends 344 of the fibers 340 define a contact surface, which is contiguous with the fiber tip curve 350. Since in the depicted embodiment, the restraining device 314 includes the plurality of radially oriented flexible fibers 340 extending along a surface, i.e. the contact surface, that is elongate in a direction generally parallel to a rotational axis A, the initial contact point I shown in cross section in FIG. 23 would extend to form an initial contact line that is generally parallel to the rotational axis A of the roll R. The fibers 340 are configured such that when fibrous sanitary tissue product TP is drawn in the first drawing direction D₁, which is generally parallel with or offset angularly above (per the orientation shown in FIG. 24) a plane that is perpendicular to the contact surface at an initial contact line, which is the initial contact point I shown in FIG. 23 extended axially parallel with the rotational axis A, fibers 340 generally adjacent the initial contact line that are contacted by the fibrous sanitary tissue product deflect away from the sheet roll material as the fibrous sanitary tissue product is continuing to be drawn in the first drawing direction D₁.

The fibers 340 are also configured such that when fibrous sanitary tissue product is drawn over the contact surface (see fiber tip curve 350 in FIG. 22) in a second drawing direction D₂, the resistance imparted on the fibrous sanitary tissue product TP by the plurality of fibers 340 overcomes the rupture strength of the fibrous sanitary tissue product (at least at a perforation in the sanitary tissue product). This results in the leading end of the fibrous sanitary tissue product TP breaking away from the remainder of the roll R. With reference to FIG. 25, the second drawing direction D₂ is angularly offset with respect to the tangent line L (FIG. 22) intersecting at the initial contact point I in a direction toward a portion of the fiber tip curve 350 located beyond the initial contact point in the first drawing direction D₁ (FIGS. 23 and 24). As more of the leading end of the fibrous sanitary tissue product comes in contact with the contact surface defined by the distal ends 344 of the fibers 340, the flexural resistance of the fibers in contact with the fibrous sanitary tissue product TP is greater than the strength of the fibrous sanitary tissue product along at least one perforation of the sheet roll material. Accordingly, the fibrous sanitary tissue product can break off at one of the perforations thus providing a quantity of material for use by an operator of the dispenser.

When the sheet roll material is drawn across the flexible fibers 340 in the first drawing direction, the resistance between the flexible fibers 340 and the sheet roll material in the direction opposite the first drawing direction is not great enough to overcome the rupture strength of the perforations found in a conventional roll of toilet tissue or a conventional roll of paper towels. However, when the sheet roll material is drawn across the flexible fibers 340 in the second drawing direction, the resistance between the flexible fibers 340 and the sheet roll material in the direction opposite the second drawing direction is great enough to overcome the rupture strength of the perforations found in a conventional roll of toilet tissue or a conventional roll of paper towels. Accordingly, a free end of the sheet roll material breaks off.

The configuration of the radially oriented flexible fibers 340 allows for a simple one-handed operation to dispense fibrous sanitary tissue product from the roll R. An operator simply pulls in a first drawing direction D₁, which can be generally parallel to a tangent line intersecting the fiber tip curve 350 at an initial contact point I or angularly offset away from the distal ends 344 of the fibers 340 located beyond the initial contact point I in the first drawing direction. When the desired amount of material has been dispensed from the remainder of the roll R, the operator changes the direction that he is pulling on the sheet roll material. The operator now pulls the sheet roll material toward (downwardly per the orientation shown in FIG. 25) the distal ends 344 of fibers 340 located beyond the initial contact point I, or line, which results in the flexible fiber 340 grabbing the material so that the desired amount of material can be removed, e.g. torn, from the remainder of the roll. The embodiment depicted in FIGS. 1-8 can operate in the same manner, i.e. an operator pulls in the first drawing direction D₁ to dispense and the operator pulls in the second drawing direction D₂ to tear the sheet roll material.

An example of a method for dispensing sheet roll material includes placing the roll R of sheet roll material in the sheet roll dispenser 310, drawing the sheet roll material in the first drawing direction D₁, and then drawing the sheet roll material in the second drawing direction D₂. As mentioned above, the roll R of sheet roll material can have perforations, similar to known rolls of toilet tissue or paper towels. The perforations can be aligned generally parallel to the axis of rotation A of the roll R. In the exemplary method, the sheet roll dispenser 310 includes the fibers 340 having distal ends 344 that define the fiber tip curve 350 in a cross section taken normal to the axis of rotation for the roll R. The sheet roll material is drawn over the plurality of fibers 340 in the first drawing direction D₁. The first drawing direction can be either (1) generally coextensive with the tangent line L (FIG. 22) that intersects the initial contact point I, which is where the sheet roll material first contacts the fibers 340 in the first drawing direction, or (2) angularly offset with respect to the tangent line L away from the distal ends 344 of the fibers 340 beyond the initial contact point I in the first drawing direction D₁. Sheet roll material is then drawn over the plurality of fibers 340 in the second drawing direction D₂. The second drawing direction is angularly offset toward the distal ends 344 of fibers 340 located beyond the initial contact point I in the first drawing direction D₁.

Drawing, the sheet roll material over the plurality of fibers 340 in the first drawing direction D₁ results in a portion of the sheet roll material being unwound from the sheet roll R. This is due to the configuration of the fibers 340 and the material from which they are made, whereby the fibers 340 deflect away from the sheet roll material as the sheet roll material is continuing to be drawn over the fibers in the first drawing direction D₁. Drawing the sheet roll material over the plurality of fibers 340 in the second drawing direction D₂ results in a portion of the sheet roll material being torn from the sheet roll. This is because as the sheet roll material contacts more of the contact surface defined by the distal ends 344 of the plurality of flexible fibers 340, and the flexural resistance of the fibers 340 along the contact surface intersecting with the sheet roll material is greater than the strength of the sheet roll material along at least one of the perforations.

Drawing the sheet roll material over the plurality of fibers in the second drawing direction D₂ results in enough individual fibers 340 contacting the sheet roll material and imparting a resistance force on the sheet roll material to exceed a tensile strength of the sheet roll material (at least at the perforations) to result in a portion of the sheet roll material tearing from the roll R. The small diameter (described above) of the distal ends of each filament 346 allow the fibers 340 to engage with the undulations of the fibrous sheet roll when the sheet roll is drawn in the second drawing direction D₂.

With reference back to FIG. 21, as mentioned above the sheet roll dispenser 310 can also include a fluid dispenser 316. The roll carrier 312 can define a fluid dispenser receptacle 360 for receiving the fluid dispenser 316. With reference to FIG. 21, the fluid dispenser 316 includes a container 362, which as depicted is generally cylindrical in configuration. The container 362 can take other configurations. A conventional pump spray top 364 having a trigger 366 fits onto the container 362 to contain a fluid 368 within the container. A dip tube 372 extends down from a conventional valve (not shown) and is in selective fluid communication with an outlet 374. An operator squeezes the trigger 366 to operate the valve to dispense fluid 368 via the outlet 374 onto paper that has been dispensed from the roll R.

As more clearly seen in FIG. 20, the mouth 332 of the roll carrier 312 includes the curved internal surface 336 that, in the depicted embodiment, is generally parallel to the external surface 334. The internal surface 336 defines a boundary of the receptacle 360. The container 362 of the fluid dispenser 316 has a configuration that substantially matches the internal surface 336 of the receptacle 360. Accordingly, where the container 362 takes an alternative configuration, the internal surface 36 of the receptacle 360 can also take an alternative configuration.

To dispense fluid 368 onto the sheet roll, one removes the fluid dispenser 316 from the sheet roll dispenser 310 and dispenses the fluid from the fluid dispenser 316 onto sheet roll material that has been dispensed from the sheet roll dispenser 310. Accordingly, moist toilet tissue and/or paper towel rolls can be conveniently dispensed without requiring the consumer to purchase separate moistened toilet tissue or wipes.

FIGS. 26 and 27 depict an alternative embodiment of a sheet roll dispenser 400. The sheet roll dispenser 400 generally includes a roll carrier 412 and a restraining device 414, similar to the sheet roll dispenser 10 described above. The roll carrier 410 is configured to support a roll of fibrous sheet roll material R, which can include a conventional roll of toilet tissue (shown in FIG. 26) and/or a conventional roll of paper towels. The roll carrier 412 is also configured to support a careless roll of toilet tissue or paper towels and can be easily loaded by simply dropping the roll R into the case. The roll carrier 412 can be a plastic integrally molded piece, e.g., made from a one piece construction. Alternatively, the roll carrier 412 can be another construction, e.g. a wire supports or a metal housing, that is configured to support a roll R of fibrous sheet roll material. The fluid dispenser 16, described above, can also be used with the sheet roll dispenser 410 to moisten the dispensed sheets.

The roll carrier 412 depicted in FIGS. 26 and 27 includes side walls 420 and 422 that are interconnected by a support wall 424. In the embodiment illustrated in FIGS. 26 and 27, the side walls 420 and 422 are generally planar in configuration and they are spaced from one another in a direction parallel to a rolling, or rotational, axis A of the roll R. The side walls 420 and 422 can be spaced from one another to accommodate a conventional roll of toilet tissue and/or a conventional roll of paper towels. The side walls 420 and 422 restrain axial movement of the roll R.

The support wall 424 that is illustrated in FIGS. 26 and 27 is generally curved to follow the radius of a conventional roll of toilet tissue and/or a conventional roll of paper towels. The support wall 424 includes a generally smooth internal surface 426 upon which the roll R rests. The internal surface 426 is smooth enough so that the roll R freely rotates on the internal surface as sheets from the roll R are being dispensed from the dispenser 410.

In the illustrated embodiment and as more clearly seen in FIG. 27, in a cross section taken normal to the rotational axis A, the internal surface 426 of the support wall 424 follows a generally constant radius, which is slightly larger than the radius of a conventional roll of toilet tissue and/or roll of paper towels. The curve of the internal surface 426, however, can take other configurations, e.g. the curve can have multiple radii.

As more clearly seen in FIG. 27, each side wall 420, 422 (only side wall 420 is visible in FIG. 27; however, side wall 422 has the same configuration) of the roll carrier 412 has a free edge 430, i.e., an edge that is not in contact with the support wall 424. For the illustrated embodiment, when a full roll R of toilet paper or paper towels is placed into the dispenser, the free edge 430 of each side wall 420, 422 that is vertically aligned with the rotational axis A is also disposed vertically below the rotational axis of a full roll R. Each side wall 420, 422 illustrated in FIG. 27 can be a generally crescent-moon shape, which can limit the material required to make the roll carrier 412 as compared to known sheet roll dispensers. If desired, a lid (not shown) can be provided to cover the remainder of the sheet roll material and such a lid can retract into the roll carrier 412 generally following the outer circumference of a full roll of conventional toilet tissue and/or roll of paper towels or the curve of the internal surface 426 of the support wall 424.

The sheet roll dispenser 400 also includes a mouth 432 over which sheet roll material from the roll R is drawn to be dispensed from the roll carrier. The mouth 432 is adjacent a sheet roll outlet for the roll carrier 412, and therefore can be referred to as an outlet-side mouth. The mouth 432 can be integrally formed with the remainder of the roll carrier 412 so that the mouth and the roll carrier are formed from one piece of material, e.g., the mouth and the roll carrier are made from a single molded piece of plastic. In the illustrated embodiment, the mouth 432 includes a curved external surface 434 and a curved internal surface 436. The restraining device 414 is located on the mouth 432, and more particular to the illustrated embodiment, the restraining device 414 is disposed on the external surface 434 of the mouth 432. As more clearly seen in FIG. 27, the mouth 432 of the roll carrier 412 includes the curved internal surface 436 that, in the depicted embodiment, is generally parallel to the external surface 434. The internal surface 436 defines a boundary of a fluid dispenser receptacle 460. The container 62 of the fluid dispenser 16 has a configuration that substantially matches the internal surface 436 of the receptacle 460. Accordingly, where the container 62 takes an alternative configuration, the internal surface 436 of the receptacle 60 can also take an alternative configuration.

In the embodiment depicted in FIGS. 26 and 27, the restraining device 414 includes a plurality of radially oriented flexible fibers 440 that are similar to the radially oriented fibers described above 40. The restraining device 414 acts in the same manner as the restraining device 14 described above, and therefore, for the sake of brevity further description of the restraining device 414 is not provided.

Different than the embodiment depicted in FIGS. 19 and 20, for the embodiment depicted in FIGS. 26 and 27 the support wall 424 includes a slot 470 that extends through the support wall and is located adjacent the mouth 432. The slot 470 is at least as wide as a conventional roll of toilet paper and/or a conventional roll of paper towels, and is preferably slightly larger than a conventional roll of toilet paper and/or a conventional roll of paper towels. The free end of the sheet roll material that is being dispensed travels through the slot 470 as it is being dispensed en route to the restraining device 414. Accordingly, the slot 470 acts as a sheet roll outlet.

The dispenser 410 depicted in FIGS. 26 and 27 is more amenable to being mounted to a wall where the rotational axis A of the roll R is normal to the vertical wall surface, while the dispenser 110 depicted in FIGS. 19 and 20 is more amenable to being mounted to a wall where the rotational axis A of the roll R is parallel to the vertical wall surface.

Sheet roll dispensers and methods for dispensing sheet roll material have been described above with particularity. It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A sheet roll dispenser comprising:
a roll carrier configured to support an associated roll of fibrous sanitary tissue product and to allow the associated roll to rotate with respect to the roll carrier to dispense sheet roll material from the associated roll when a free end of the associated roll is drawn in a drawing direction;
an outlet-side mouth connected with the roll carrier; and
a restraining device on the mouth, the restraining device including a plurality of flexible fibers having distal ends defining a fiber tip curve.

2. The sheet roll dispenser of claim 1, wherein the mouth includes an external surface, each fiber has a central axis generally perpendicular with respect to a location on the external surface where the respective central axis intersects with the external surface.

3. The sheet roll dispenser of claim 2, further comprising a fluid dispenser, wherein the roll carrier defines a fluid dispenser receptacle for receiving the fluid dispenser.

4. The sheet roll dispenser of claim 3, wherein the mouth includes a curved internal surface that is generally parallel to the external surface, wherein the internal surface defines a boundary of the fluid dispenser receptacle.

5. The sheet roll dispenser of claim 2, wherein the mouth is integrally formed with the roll carrier and is positioned below a sheet roll outlet.

6. The sheet roll dispenser of claim 1, wherein the fibers are configured to flex toward a direction in which fibrous sanitary tissue product is being drawn.

7. The sheet roll dispenser of claim 6, wherein the fibers are configured such that when fibrous sanitary tissue product is drawn in a first drawing direction that is generally parallel with respect to a tangent line intersecting the fiber tip curve at an initial contact point, which is where the fibrous sanitary tissue product first contacts the fibers in the first drawing direction, the fibers deflect away from the fibrous sanitary tissue product as the fibrous sanitary tissue product is continuing to be drawn over the fibers in the first drawing direction.

8. The sheet roll dispenser of claim 7, wherein the fibers are configured such that when fibrous sanitary tissue product is drawn in a second drawing direction that is angularly offset with respect to the tangent line intersecting at the initial contact point in a direction toward a portion of the fiber tip curve located beyond the initial contact point in the first drawing direction, a force of greater than about the rupture strength of a perforation in a conventional roll of toilet tissue in a direction that is opposite the second drawing direction is imparted on the sheet roll material that is located beyond the initial contact point in the second drawing direction.

9. The sheet roll dispenser of claim 1, wherein the fiber tip curve follows a radius.

10. The sheet roll dispenser of claim 9, wherein the fiber tip curve is at least one-quarter of a circle.

11. The sheet roll dispenser of claim 1, wherein the distal ends of the fibers define a contact surface, the fibers are configured such that when fibrous sanitary tissue product is drawn in a first drawing direction that is generally parallel with respect to a tangent line intersecting the curve at an initial contact line, which is where the fibrous sanitary tissue product first contacts the fibers as determined in the drawing direction, the fibers generally adjacent the initial contact line that are contacted by the fibrous sanitary tissue product deflect away from the fibrous sanitary tissue product as the fibrous sanitary tissue product is continuing to be drawn in the first drawing direction.

12. The sheet roll dispenser of claim 1, wherein the flexible fibers include nylon filaments having a diameter between about 10 micrometers and about 20 micrometers, wherein the filaments are bundled into tufts.

13. A method for dispensing sheet roll material comprising:
placing a roll of fibrous sanitary tissue product having perforations in a sheet roll dispenser including fibers having distal ends that define a fiber tip curve;
drawing the fibrous sanitary tissue product over the plurality of fibers in a first drawing direction, wherein the first drawing direction is (1) generally coextensive with a tangent line that intersects an initial contact point, which is where the fibrous sanitary tissue product first contacts the fibers in the first drawing direction, or (2) angularly offset from the tangent line away from the distal ends of the fibers located beyond the initial contact point in the first drawing direction; and
drawing the fibrous sanitary tissue product over the plurality of fibers in a second direction, wherein the second direction is angularly offset away from the tangent line toward the distal ends of the fibers located beyond the initial contact point in the first drawing direction.

14. The method of claim 13, wherein drawing the fibrous sanitary tissue product over the plurality of fibers in the first drawing direction results in a portion of the fibrous sanitary tissue product being unwound from the roll without tearing the fibrous sanitary tissue product at one of the perforations.

15. The method of claim 13, wherein drawing the fibrous sanitary tissue product over the plurality of fibers in the second direction results in a portion of the fibrous sanitary tissue product being torn from the roll.

16. The method of claim 15, wherein drawing the fibrous sanitary tissue product over the plurality of fibers in the second direction results in a portion of the fibrous sanitary tissue product being torn from the roll at one of the perforations.

17. The method of claim 16, wherein drawing the fibrous sanitary tissue product over the plurality of fibers in the second direction results in enough individual fibers contacting the fibrous sanitary tissue product and imparting a resistive force on the fibrous sanitary tissue product to exceed a tensile strength of the fibrous sanitary tissue product at the perforations to result in a portion of the fibrous sanitary tissue product tearing from the roll.

18. The method of claim 12, wherein drawing the fibrous sanitary tissue product over the plurality of fibers in the second direction results in enough individual fibers contacting the fibrous sanitary tissue product and imparting a resistive force on the fibrous sanitary tissue product to exceed a tensile strength of the fibrous sanitary tissue product at one of the perforations to result in a portion of the fibrous sanitary tissue product from the roll.

19. The method of claim 12, further comprising:
removing a fluid dispenser from the sheet roll dispenser; and
dispensing fluid from the fluid dispenser onto fibrous sanitary tissue product that has been dispensed from the sheet roll dispenser.

20. A sheet roll dispenser comprising:
a roll carrier configured to support an associated roll of fibrous sheet roll material, wherein the roll carrier includes a mouth and a fluid dispenser receptacle, the mouth including an external surface over which sheet roll material from the associated roll is drawn to be dispensed from the roll carrier and a curved internal surface that defines a boundary of the fluid dispenser receptacle; and
a fluid dispenser disposed in the fluid dispenser receptacle and including a container for holding fluid, the container having a configuration that substantially matches the internal surface of the fluid dispenser receptacle.
